(19) United States
(12) Patent Application Publication
(10) Pub. No.: US 2009/0064837 A1
(43) Pub. Date: Mar. 12, 2009

(54) Scissors with attached illumination means

(76) Inventor: Bernard Merlino, Manchester, NJ (US)

Correspondence Address: CLIFFORD G. FRAYNE, 136 DRUM POINT RD, SUITE 7A, BRICK, NJ, 08723, US

(21) Appl. No.: 11/899,944

(22) Filed: Sep. 10, 2007

(51) Int. Cl. B26D 7/00

(52) U.S. Cl. 83/520

(57) ABSTRACT

A scissors assembly for the cutting, trimming or shearing of objects, the assembly having an incorporated illumination source for illuminating the objects, the scissor assembly and illumination source being particularly adapted to the trimming of nose hair.

### BACKGROUND OF THE INVENTION

1. Field of the Invention

The present invention relates to scissors and other scissor-like implements, and in particular to scissors designed for trimming nose hair, which scissors would include an illumination means mounted thereon.

2. Description of the Prior Art

Scissors and scissor-like instruments or implements have been designed specifically for a multitude of tasks. Specially designed scissors are utilized by individuals in the garment and sewing trade to cut fabric; specially designed scissors of a smaller scale are utilized to trim fingernails and toenails; and larger scissor-like instruments, such as shears and garden clippers, are utilized to trim flowers, hedges and other types of vegetation.

Applicant's invention would have application to all of these specialized scissors and scissor-like instruments if and when they were being used in situations of low visibility such that an illumination means would enhance their performance. Applicant's specific application and novel contribution is to the specially designed scissors utilized for trimming nose hair.

Typically scissor construction requires a pivot point defined by a rivet or other suitable fastening means which secures together two complimentary, elongated members, each member comprising a handle end, a shank portion, and a blade portion, such that the opening and closing of the complimentary handle ends causes a similar opening and closing of the blade portions which in turn act upon the substance to be cut. Scissors designed for trimming nose hairs are of a similar design, however the blade portions are relatively short compared to conventional scissor construction and the tips of the blade portions are somewhat rounded for safety reasons due to the fact that they are operating proximate the inner membrane of the nose when being used.

The user of the nose hair scissors when trimming nose hair would most likely be in front of a mirror with adequate lighting, but even with adequate lighting, the orientation of the head oftentimes makes it difficult for the individual to adequately visually identify the area to be trimmed and therefore there is a need for a light source which could be positioned in substantial alignment with the blades of the nose hair scissors, which light source would be light weight and not interfere with the operation of the nose hair scissors, but would provide illumination directly to the area being trimmed.

### OBJECTS OF THE INVENTION

An object of the present invention is to provide for a novel scissors assembly which includes a light source, which light source illuminates the cutting area.

Another object of the present invention is to provide for a novel scissors assembly for the trimming of nose hair in which a light source is affixed to the scissors.

A still further object of the present invention is to provide for a novel scissors assembly with an incorporated light source, which light source is secured to the shank portion of one of the handles of the scissors.

Another object of the present invention is to provide for a novel scissor assembly in which the light source is battery powered.

### SUMMARY OF THE INVENTION

A scissors assembly for the cutting, trimming or shearing of objects, the assembly having an incorporated illumination source for illuminating the objects, the scissor assembly and illumination source being particularly adapted to the trimming of nose hair.

### BRIEF DESCRIPTION OF THE DRAWINGS

These and other objects of the present invention will become apparent, particularly when taken in light of the following illustrations wherein:

FIG. 1 is a top planar view of a typical scissor assembly specifically designed for the trimming of nose hair;

FIG. 2 is a top view of the scissor assembly of FIG. 1 with an illumination source attached thereto;

FIG. 3 is a side view of the scissor assembly of FIG. 2 with an illumination source affixed thereto;

FIG. 4 is a perspective view of a scissor assembly and illumination means utilized to cut fabric; and

FIG. 5 is a top view of a garden shear assembly with illumination means.

### DETAILED DESCRIPTION OF THE INVENTION

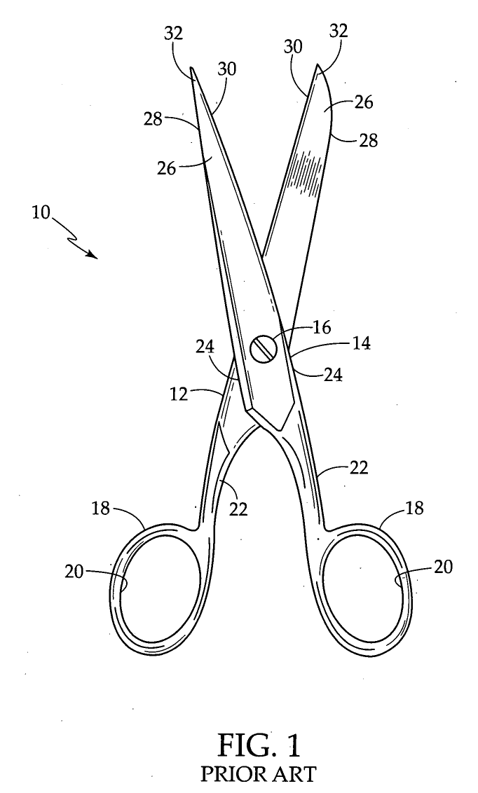

FIG. 1 is a top planar view of a typical scissor assembly specifically designed for the trimming of nose hair. The scissor assembly 10 is formed of two complimentary longitudinal members 12 and 14. Longitudinal members 12 and 14 are secured at a pivot point 16 by means of a rivet or other suitable fastening means such that longitudinal members 12 and 14 may pivot in the same plane with respect to each other. Each longitudinal member 12 and 14 consists of three distinct portions. A handle portion 18 is formed in a loop 20 which allows for the insertion of a finger of the user therethrough. The handle portion 18 melds into a shank portion 22, having an inner and outer surface, the opposing end 24 of the shank portion 22 having an aperture therethrough, defining the pivot point 16 wherein longitudinal members 12 and 14 are pivotally joined by a suitable fastening means. The shank portion 22 then melds into the blade portion 26 in which the outer edge 28 of the blade portion is blunt or dull and the inner edge 30 sharpened to form a cutting surface. Since the scissor 10 illustrated is specifically designed for trimming nose hair and is inserted into the nostril and operates proximate the mucus membrane of the inner nose, the tips 32 of the blade portion of each longitudinal member 12 and 14 are rounded, as opposed to pointed in other specifically designed scissors, in order to avoid injury. In operation, the nose hair scissors are manipulated by the insertion of the thumb and forefinger through the loop 20 in the handle portion 18 of the scissors.

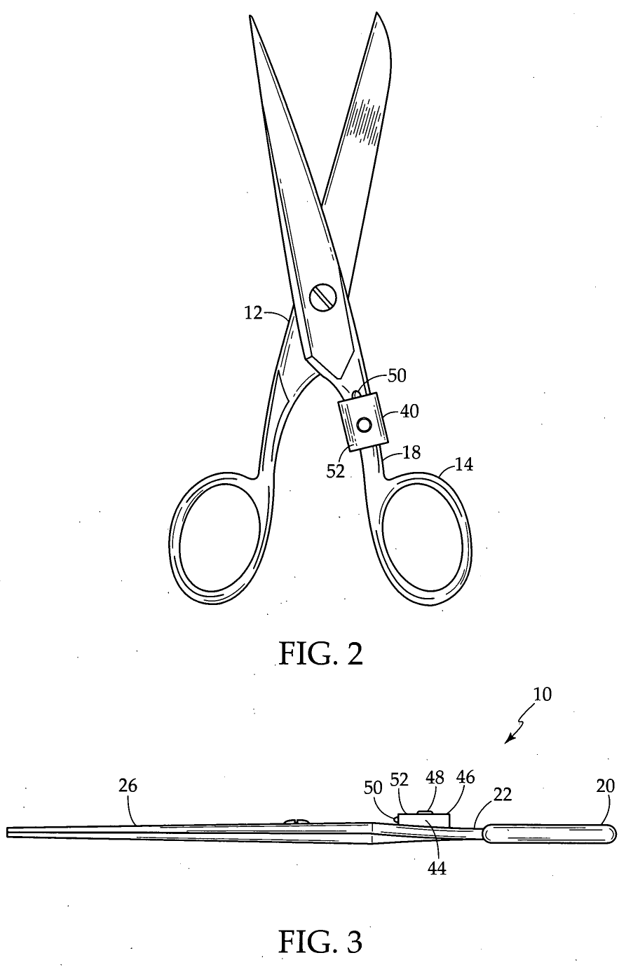

FIG. 2 is a planar top view of the nose hair scissors 10 of FIG. 1 with an illumination device secured thereto and FIG. 3 is a side view. In the configuration illustrated in FIG. 2, the illumination device 40 is secured to the outer surface of the shank portion 18 of one of the longitudinal members 12 or 14. In the preferred embodiment, the light source is positioned in a plastic, preferably polycarbonate case 42 of minimal weight. The case would contain a battery compartment 44 to house the power source 46. It will be recognized by those skilled in the art that the power source 46, i.e. battery, will be the largest element of the light source, and therefore define the size and weight of the light source. Applicant has found that a casing having a battery housing which would accommodate either two lithium CR2016 or one lithium CR2032 batteries will weight approximately 8 grams and can be attached to the shank 18 of one of the longitudinal members 12 or 14 without interfering with the manipulation of the scissors 10. The batteries would be connected to an on/off switch 48, and in turn to a light emitting diode 50 as the illumination source. The light emitting diode 50 is positioned in the casing 42 and is in alignment with the longitudinal members 12 and 14 when in a closed position.

The on/off switch 48 would preferably be a pressure sensitive button positioned on the upper surface 52 of the casing 42, which when depressed would activate the illumination source, and which when depressed a second time would inactivate the illumination source.

Since the illumination source illustrated in FIGS. 1-3 is attached to the shank 18 of only one of the longitudinal elements, it will necessarily pivot with that particular shank portion when the scissors are manipulated, however, since the blade portion 26 of the nose hair scissors are short, and the area to be trimmed is rather small, the light source will still illuminate the area to be trimmed despite being slightly angularly askew.

In the preferred embodiment, at least one shank portion 18 of longitudinal members 12 and 14 would be planar in order to facilitate the location and attachment of the illumination casing 42.

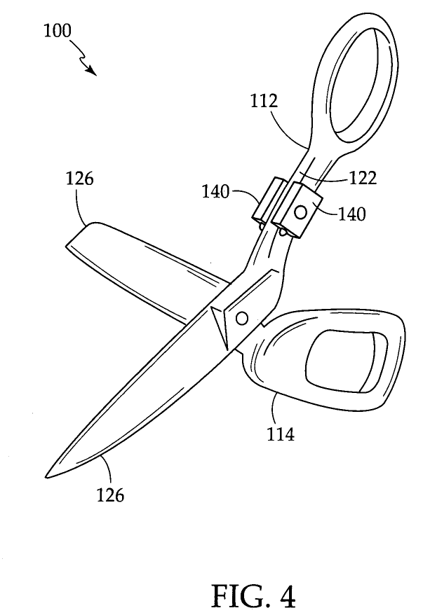

FIG. 4 is a perspective view of a scissor assembly 100, which scissor assembly may be specifically designed for cutting and shaping cloth or garment material. The scissor assembly is constructed in a manner similar to the scissor assembly illustrated in FIG. 1 with the exception that the dimensions of the longitudinal members 112 and 114 and shank portions 122 and blade portions 126 are of larger dimension. The illumination device 140 would be positioned in the same manner as illustrated in FIG. 1, however, due to size of the larger scissor assembly 100, it may be desirable to have a second illumination device 140 positioned on the opposing shank portion 122 of the opposing longitudinal member 114.

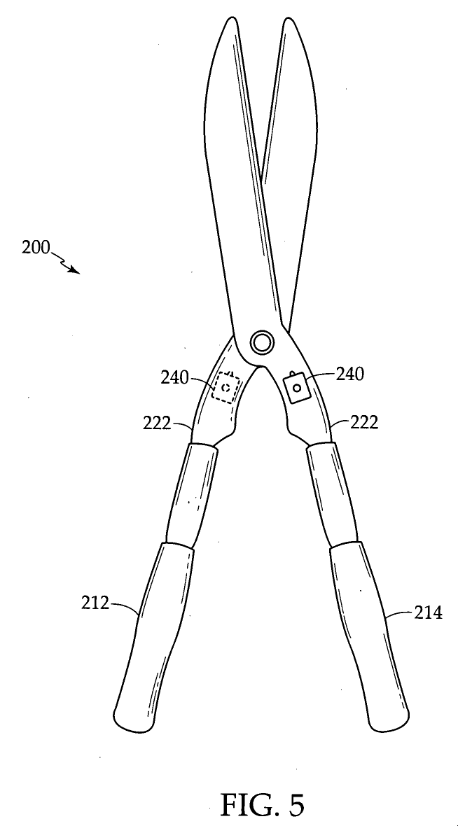

FIG. 5 is a top view of a scissor assembly in the form of a garden shear 200. The garden shear 200 would be even larger than the scissor assembly of FIG. 4 and would normally be operated with two hands. In this embodiment, an illumination device 240 would be positioned on the outer shank portions 222 of both longitudinal members 212 and 214.

It will be recognized that Applicant's scissor assembly and illumination device is dependent upon a power source in the form of a battery and that the size of the battery dictates the size of the housing for the illumination device in that the battery is the largest component thereof. Therefore, while the various embodiments illustrated herein are so illustrated with the lightest and smallest battery source available to Applicant, it will be understood that as battery sizes are reduced, the size of the housing can similarly be reduced which would have particular application and scissor-like assemblies of small dimension.

Therefore, while the present invention has been disclosed with respect to the preferred embodiments thereof, it will be recognized by those of ordinary skill in the art that various changes and modifications can be made without departing from the spirit and scope of the invention. It is therefore manifestly intended that the invention be limited only by the claims and the equivalence thereof.

I claim:

1. A scissor assembly with attached illumination means comprising:
a scissor assembly with two complimentary longitudinal members, each member comprising a handle portion, a shank portion, and a blade portion, said two complimentary longitudinal members secured at a pivot point, there being secured to a shank member proximate said pivot point, an illumination means, said illumination means comprising a housing member, said housing member defining a battery compartment, a switch means, and a light emitting diode, said light emitting diode positioned in said casing, and facing said blade portion of said complimentary longitudinal members.

2. The scissor assembly with attached illumination means in accordance with claim 1 wherein said illumination means is secured to said shank portion of one of said longitudinal members by means of an adhesive.

3. The scissor assembly with attached illumination means in accordance with claim 2 wherein said longitudinal members having said illumination means secured thereto is planar and cooperative with said housing of said illumination means for securing said illumination means to said shank portion.

4. The scissor assembly with attached illumination means in accordance with claim 1 wherein battery source comprises lithium batteries.

5. The scissor assembly with attached illumination means in accordance with claim 1 wherein said on/off switch selectively activates and deactivates said light emitting diode.

6. The scissor assembly with attached illumination means in accordance with claim 1 wherein said illumination means is particularly adapted to attachment to a scissor assembly adapted for trimming nose hair.

7. The scissor assembly with attached illumination means in accordance with claim 1 wherein said scissor assembly comprises a garment scissor having an illumination means attached to each shank portion of said longitudinal members.

8. The scissor assembly with attached illumination means in accordance with claim 1 wherein said scissor assembly comprises a garden shear having said illumination means attached to each shank portion of said longitudinal members.
